(19) United States
(12) Patent Application Publication
(10) Pub. No.: US 2010/0232081 A1
(43) Pub. Date: Sep. 16, 2010

(54) Method and Apparatus for Over-voltage Protection With Breakdown-Voltage Tracking Sense Element

(75) Inventor: Donald Disney, Cupertino, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Santa Clara, CA (US)

(21) Appl. No.: 12/402,793

(22) Filed: Mar. 12, 2009

(51) Int. Cl. H02H 3/20

(52) U.S. Cl. 361/91.5; 361/91.1

(57) ABSTRACT

A power integrated circuit with internal over-voltage protection includes a power transistor monolithically integrated with a sense element and a control circuit. The power transistor is connected to an output terminal that is connected (or is connectable) to an external load. The sense element is connected to the output terminal in parallel with the power transistor. The sense element is constructed to be similar to the power transistor except that the sense element has a lower breakdown voltage. When the voltage of the output terminal exceeds the breakdown voltage of the sense element a breakdown current flows from the gate of the sense element to the control circuit. Inside the control circuit, a comparator or other over-voltage protection circuit monitors this feedback and controls the power transistor accordingly to protect the power integrated circuit from damage.

### BACKGROUND OF THE INVENTION

Power integrated circuits (PICs) are used in many applications. PICs typically combine control circuitry with one or more monolithically-integrated power transistors. Power transistors are capable of handling voltages and/or currents that are significantly higher than standard analog or digital integrated circuit devices. A common requirement in the design of PICs is to monitor the voltage on one or more output terminals and provide protection for the PIC if this voltage exceeds a safe level. It is important to implement this over-voltage protection (OVP) function in a low-cost, compact manner and to minimize tolerances in order to minimize the design margin required for the power transistors. The power transistors in PICs typically have a clamp structure placed in parallel with each power transistor. The clamp is designed to have a lower breakdown voltage than that of the power transistor, so that the clamp, rather than the power device, takes the energy dissipated during an over-voltage condition such as electrical over-stress (EOS) or electrostatic discharge (ESD).

In prior art implementations, OVP has been accomplished using an external resistor divider to reduce the signal from the high voltage output to a lower voltage that is compatible with another input of the PIC. One shortcoming of this approach is the addition of the external resistors, which adds size and cost to the solution. Another problem is the inability to trim out the variation in the resistor values, which necessitates the use of expensive, high-precision resistors and/or increased tolerances on the OVP specification. The clamping function in PICs is typically accomplished by a diode structure that has a different construction than that of the power device it is protecting, which has the disadvantage of exhibiting process variation that is not aligned with the process variation of the power device, such that increased breakdown voltage (BV) margin is required when designing the power device.

One example prior-art solution is shown in FIG. 1. In this figure, PIC 11 has a main output terminal 12 through which an external load 13 is controlled by power transistor 14, which is protected by parallel clamp element 15. External resistors 16A and 16B are placed between output 12 and common terminal 17. The voltage at the intermediate connection of resistors 16A and 16B is coupled to an OVP input 18 of PIC 11. Inside the PIC, a comparator or other OVP circuit 19 is connected to OVP input 18.

### SUMMARY OF THE INVENTION

The present invention provides a power IC with internal over voltage protection (OVP). For a typical embodiment, a package includes at least a power transistor monolithically integrated with a sense element and a control circuit. The power transistor is connected to an output terminal that is connected (or is connectable) to an external load. The sense element is connected to the output terminal in parallel with the power transistor.

The sense element is constructed to be similar to the power transistor except that the sense element has a lower breakdown voltage (BV). Typically, this is accomplished by fabricating the sense element and power transistor to have similar drift regions with the drift region of the sense element being shorter. The advantage of this construction is that the breakdown voltages of the power transistor and the sense element will track each other with process variation and temperature.

The gate of the sense element is connected to provide feedback to the control circuit. Specifically, when the voltage of the output terminal exceeds the breakdown voltage of the sense element a breakdown current flows from the gate of the sense element to the control circuit. Inside the control circuit, a comparator or other over voltage protection circuit monitors this feedback and controls the power transistor accordingly.

In a preferred embodiment, the sense element may also serve as the clamp device that protects power transistor from damage during EOS and ESD events. In another embodiment, a clamp element is included in parallel with the power transistor and sense element. The clamp element preferably has a construction similar to the sense element, and may have an identical drift region length (providing very similar breakdown voltage) or a slightly longer drift region length (to provide a slightly higher breakdown voltage) compared to the sense element. The clamp element is preferably much larger than the sense element so that it can withstand high currents without failure. For this embodiment, the clamp element absorbs additional energy reducing the breakdown voltage current in the sense element and protecting the circuitry of the control circuit

### BRIEF DESCRIPTION OF THE DRAWINGS

FIG. 1 is a schematic diagram of a prior art PIC with external resistor divider for OVP.

FIG. 2 is a schematic diagram of one embodiment of the present invention.

FIG. 3 is a schematic cross-section of one embodiment of the present invention.

FIG. 4A is a voltage stack-up of OVP function in the prior art.

FIG. 4B is a voltage stack-up of OVP function in the present invention.

### DETAILED DESCRIPTION OF THE PREFERRED EMBODIMENTS

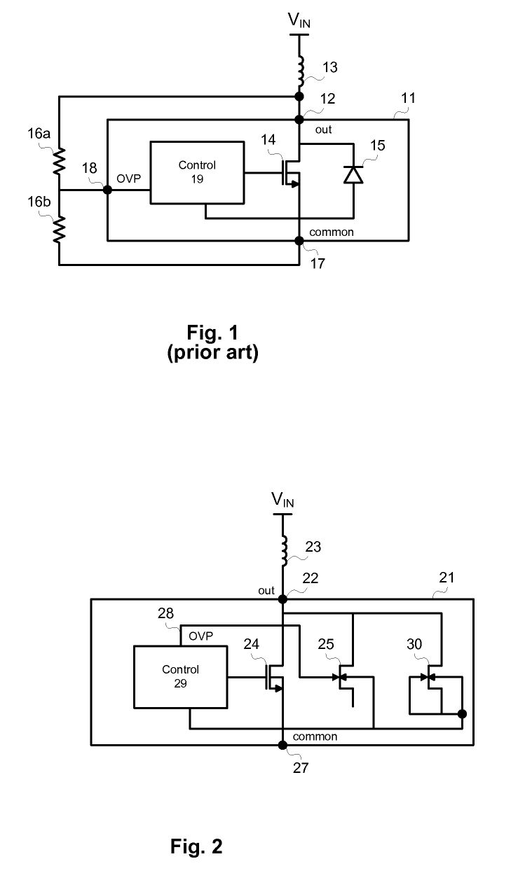

FIG. 2 shows one embodiment of the present invention. PIC 21 has a main output terminal 22 through which an external load 23 is controlled by a power transistor 24, which is protected by a parallel OVP sense element 25. Sense element 25 has a construction that is similar to that of power transistor 24, except that sense element 25 is tailored to have a lower BV than that of power transistor 24. In a preferred embodiment, power transistor 24 comprises a drift region that primarily determines the BV of this transistor, and sense element 25 has a similar drift region but with a shorter drift region length and/or changes in field plating that provide a lower BV. The advantage of this construction is that the BVs of power transistor 24 and sense element 25 will track each other with process variation and temperature. This greatly reduces the required voltage stack-up that must account for differences in these BVs over the full range of process variation and operating temperatures. In a preferred embodiment, the drift region of power transistor 24 comprises a junction field effect transistor (OFET) with a certain drift region length, and sense element 25 comprises another JFET with a shorter drift region length. In a preferred embodiment, the breakdown path of the sense JFET is accessible from the top surface of the PIC, such that a detectible breakdown current is generated when the voltage on output 22 exceeds the BV of sense element 25. The breakdown voltage path of sense element 25 (the JFET gate terminal, in this example) is coupled to internal OVP input 28 of control circuit 29. Inside control circuit 29, a comparator or other OVP circuit is connected to OVP input 28 and this OVP circuit responds to the breakdown current by turning off or otherwise modifying the operation of power transistor 24 in order to protect PIC 21 from damage. This direct connection of the OVP detection signal obviates the need for external resistors, saving area and cost, and also avoiding the OVP variations introduced by the tolerances of external resistors.

In a preferred embodiment, sense element 25 may also serve as the clamp device that protects power device 24 from damage during EOS and ESD events. In another embodiment, optional clamp element 30 may be included in parallel with power transistor 24 and sense element 25. Because the breakdown current in sense element 25 is coupled to control circuit 29, it may be desirable to keep this breakdown current to a relatively low level, to avoid damaging the control circuit. In this case, clamp element 30 may be used to absorb any additional energy. Clamp 30 preferably has a construction similar to sense element 25, and may have an identical drift region length (providing very similar BV) or a slightly longer drift region length (to provide a slightly higher BV) compared to sense element 25. Clamp element 30 is preferably much larger than sense element 25, such that it can withstand high currents without failure.

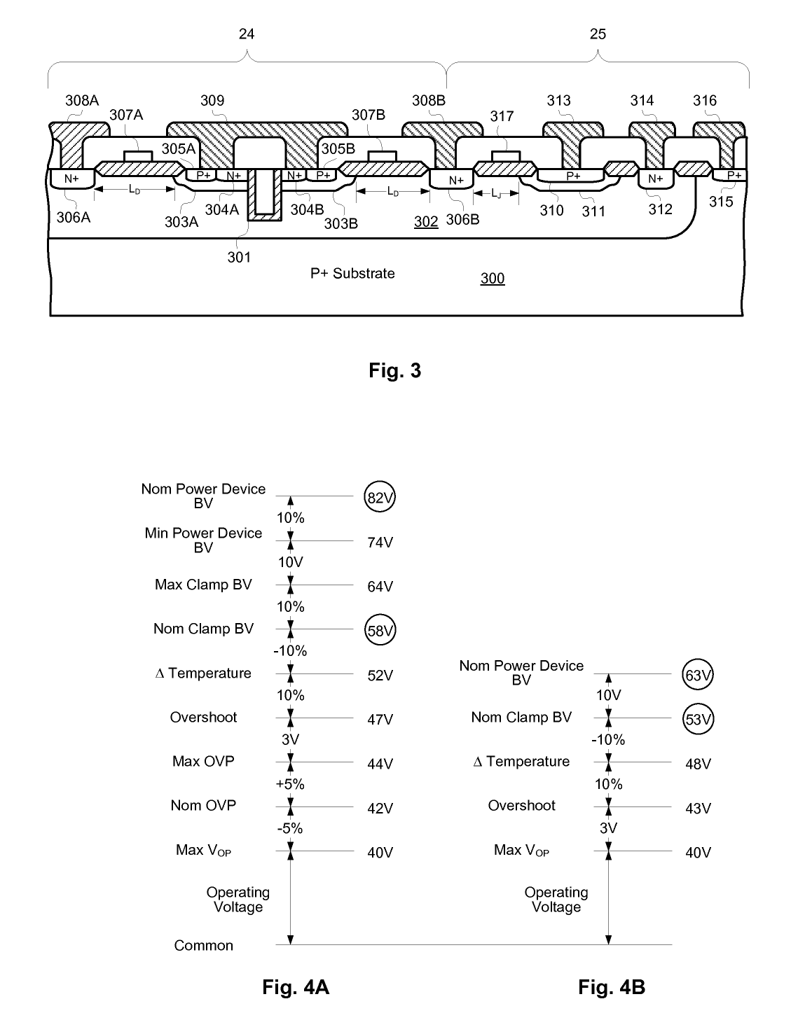

FIG. 3 shows a schematic cross-section of the power device 24 and sense element 25 in a preferred embodiment of the present invention. Although many different power device designs may be utilized within the scope of this invention, a lateral trench DMOS (LTDMOS) transistor 24 is shown as one example. A typical LTDMOS power transistor would comprise many parallel-connected transistors, but this illustration shows only two for the sake of clarity. LTDMOS 24 is formed in P-type substrate 300 and comprises a trench gate 301, N-drift region 302, P-body regions 303A and 303B, N+ source regions 304A and 304B, P+body contact regions 305A and 305B, and N+drain regions 306A and 306B. Drift regions with length LD are defined by the spacing between P-body 303 and drain 306. Optional field plates 307A and 307B are disposed over the drift regions. Drain electrodes 308A and 308B and source/body electrode 309 are formed to provide electrical contact to the drain and source regions. Trench gate 301 is contacted in the third dimension, not shown.

Although many different sense designs may be utilized within the scope of this invention, a lateral JFET 25 is shown as one example. In a preferred embodiment, JFET 25 is fabricated adjacent LTDMOS 24. In the preferred embodiment shown, these devices share a common N-drift region 302 and N+ drain region 306B, which saves layout area by merging the high-voltage portions of these devices and avoiding large spacing that would be required between isolated devices. JFET 25 also comprises P+ gate contact region 310, P-type top gate region 311, and an optional N+ source region 312. A JFET drift region with length LJ is defined by the spacing between top gate 311 and drain 306B. In a preferred embodiment, LJ is shorter than LD, such that the BV of JFET 25 is lower than the BV of LTDMOS 24. Optional field plate 317 is disposed above the JFET drift region. JFET gate electrode 313 and optional JFET source electrode 314 provide electrical contact to the top gate and optional source regions. An optional P+ field stop region 315 surrounds the combined power device and clamp structure, and is contacted by substrate electrode 316. In a preferred embodiment, JFET source electrode 314 is absent while substrate electrode 316 is shorted to LTDMOS source/body electrode 309.

In a preferred embodiment, an additional clamp element may be added using a similar JFET construction as that of JFET 25. This additional clamp element may also be fabricated adjacent LTDMOS 24 and/or JFET 25, and may share some of the same regions (e.g. the drift region), to provide a compact layout.

FIG. 4A shows the voltage stack-up that dictates the BV rating of the power device in a PIC using the prior art OVP scheme. In this example, the guaranteed maximum operating voltage at the output terminal is 40V. The OVP circuit has an assumed tolerance of +/−5%. The OVP should not ever be triggered below the maximum operating voltage, so the nominal OVP threshold is set 5% above the maximum operating voltage, and the maximum OVP is another 5% above the nominal threshold, or 44V in this example. This is the maximum operating voltage that may actually be present on the output terminal. When an inductive load and external diode clamping is used, as in the case of a switching power converter, there must be some allowance for an overshoot voltage, comprising the diode voltage and inductive ringing, which is assumed to be 3V in this example. Adding this to the stack shows that the BV of the clamp element should never be below 47V. Since this voltage may be present at any operating temperature, the minimum clamp BV must be guaranteed at the lowest rated temperature, assumed to be −40° C. in this example. Because avalanche BV is known to decrease with decreasing temperature, typically by about 10% from 25° C. to 40° C., the minimum room-temperature clamp BV should be 52V. The process-induced variation of the clamp BV is assumed to be 10%, so the nominal, low-current clamp BV is set at 58V, and the maximum clamp BV is 64V. Because the clamp element is somewhat resistive, its BV will increase with increasing breakdown current. There should be adequate margin between the maximum low-current clamp BV and the minimum power device BV to allow the clamp to conduct a substantial amount of breakdown current while keeping its BV below that of the power device. A 10V margin is used in this example, giving a minimum power device BV of 74V. Because the clamp and power device in this prior-art example have independent process-induced variations, the nominal power device BV must be above its minimum value by the process margin, assumed to be 10%. As a result of stacking up all of these margins and allowances for process variation, the typical room-temperature power device BV is 82V, more than twice the maximum operating voltage that is being guaranteed on the output terminal.

FIG. 4B shows the voltage stack-up that dictates the BV rating of the power device in a PIC using the OVP scheme of the present invention. As in the previous example, the guaranteed maximum operating voltage at the output terminal is 40V. Because the OVP function is integrated into the clamp element, there is no need to include a separate process-induced OVP variation in this stack-up. The overshoot voltage of 3V is added to the maximum operating voltage, such that the BV of the clamp element should never be below 43V. To account for the BV reduction from room temperature to 40° C., a 10% factor is added, giving a minimum clamp BV of 48V. Assuming 10% process-induced variation in the clamp BV, the typical room-temperature clamp BV is 53V. Note that this is 5V lower than the minimum clamp BV of the previous example, due to the removal of the OVP tolerance requirements. As described above, the clamp is designed to have the same process dependence as the power device (e.g. if the BV of power device decreases, the BV of the clamp decreases proportionally). Therefore, there is no need to include separate process-induced variations for the clamp and power device BV. Allowing 10V margin between the clamp BV and the power device BV, the nominal room-temperature power device BV is only 63V, which is much lower than the prior-art example.

The reduced power device BV that is made possible by this invention provides a substantial cost and area benefit for the PIC. It is well known that power device on-resistance for a given die area (specific on-resistance) increases dramatically as the BV increases. Reducing the BV requirement from 82V to 63V may, for example, reduce the die area required to meet a given on-resistance target by 40% or more. Moreover, each given process technology has fundamental limits on the maximum power device BV that may be fabricated in that process. Reducing the BV requirement by 20V, as in this example, will allow the PIC to be designed in a process with a lower maximum BV, again reducing the cost of the PIC.

What is claimed is:

1. A power integrated circuit with internal over-voltage protection that comprises:
a power transistor that includes an output terminal;
a sense transistor connected to the output terminal, where the breakdown voltage of the sense transistor is lower than a breakdown voltage of the power transistor by a predetermined margin; and where a breakdown current in the sense transistor flows from the output terminal to a sense terminal; and
an over-voltage circuit coupled to the sense terminal and configured to modify the operation of the power transistor in response to the breakdown current.

2. The power integrated circuit of claim 1 in which the sense transistor and the power transistor are monolithically integrated so that the process induced variation of the breakdown voltage of the sense transistor is directly proportional to the process induced variation of the breakdown voltage of the power transistor.

3. The power integrated circuit of claim 1 further comprising a clamp transistor coupled to the output terminal and having a breakdown voltage that is lower than the breakdown voltage of the power device by a clamp breakdown voltage margin.

4. The power integrated circuit of claim 3 in which the clamp transistor and the power transistor are monolithically integrated so that the process induced variation of the breakdown voltage of the clamp transistor is directly proportional to the process induced variation of the breakdown voltage of the power transistor.

5. The power integrated circuit of claim 1 wherein:
the power transistor comprises a drift region with a JFET-like construction and a first drift region length;
the sense transistor comprises a drift region with a JFET-like construction, and a second drift region length; and
where the second drift region length is less than the first drift region length.

6. The power integrated circuit of claim 1 wherein the power transistor comprises a lateral trench DMOS.

7. The power integrated circuit of claim 1 wherein the sense transistor comprises a JFET and the breakdown path of the sense transistor is through a top-gate of the JFET.

8. The power integrated circuit of claim 7 wherein the over-voltage sense terminal comprises the top-gate of the JFET.

9. The power integrated circuit of claim 3 wherein:
the power transistor comprises a drift region with a JFET-like construction and a first drift region length;
the sense transistor comprises a drift region with a JFET-like construction, and a second drift region length;
the clamp transistor comprises a drift region with a JFET-like construction, and a third drift region length.

10. The power integrated circuit of claim 9 wherein the second drift region length is less than the first drift region length and the third drift region length is less than the first drift region length.

11. The power integrated circuit of claim 1 wherein the power transistor and the sense transistor are fabricated in a semiconductor substrate and share a common drain diffusion region.

12. A power integrated circuit (PIC) fabricated in a semiconductor substrate and comprising:
a control circuit;
a power transistor coupled to an output terminal, the power transistor having a power transistor breakdown voltage;
an over-voltage sense transistor coupled to the output terminal, the sense transistor having a sense transistor breakdown voltage, the sense transistor breakdown voltage being lower than the power transistor breakdown voltage; and
a control circuit connected to the sense transistor to provide an over-voltage protection function.

13. An over-voltage protection apparatus comprising:
a power transistor coupled to an output terminal, the power transistor having a power transistor breakdown voltage;
an over-voltage sense transistor coupled to the output terminal and comprising an over-voltage sense terminal, the sense transistor having a breakdown voltage that is lower than the power transistor breakdown voltage by a sense transistor breakdown voltage margin; and
a control circuit connected to the sense transistor to provide an over-voltage protection function when the output voltage on the output terminal exceeds the sense transistor breakdown voltage.

14. The over-voltage protection apparatus of claim 13 in which the sense transistor breakdown voltage exhibits process-induced variation that is directly proportional to the process-induced variation of the power transistor breakdown voltage, such that the sense transistor breakdown voltage margin is substantially constant within a reasonable range of process-induced variation.

15. The over-voltage protection apparatus of claim 13 further comprising a clamp transistor coupled to the output terminal and having a clamp breakdown voltage that is lower than the power transistor breakdown voltage by a clamp breakdown voltage margin.

16. The over-voltage protection apparatus of claim 15 in which the clamp breakdown voltage exhibits process-induced variation that is directly proportional to the process-induced variation of the power transistor breakdown voltage, such that the clamp breakdown voltage margin is substantially constant within a reasonable range of process-induced variation.

17. The over-voltage protection apparatus of claim 13 wherein:
the power transistor comprises a drift region with a JFET-like construction and a first drift region length;
the sense transistor comprises a drift region with a JFET-like construction, and a second drift region length;
the second drift region length is less than the first drift region length.

18. The over-voltage protection apparatus of claim 13 wherein the power transistor comprises a lateral trench DMOS.

19. The over-voltage protection apparatus of claim 13 wherein the sense transistor comprises a JFET and the breakdown path of the sense transistor is through a top-gate of the JFET.

20. The over-voltage protection apparatus of claim 19 wherein the over-voltage sense terminal comprises the top-gate of the JFET.

21. The over-voltage protection apparatus of claim 13 wherein:
the power transistor comprises a drift region with a JFET-like construction and a first drift region length;
the sense transistor comprises a drift region with a JFET-like construction, and a second drift region length;
the clamp transistor comprises a drift region with a JFET-like construction, and a third drift region length.

22. The over-voltage protection apparatus of claim 20 wherein the second drift region length is less than the first drift region length and the third drift region length is less than the first drift region length.
